(19) United States
(12) Patent Application Publication
(10) Pub. No.: US 2021/0308654 A1
(43) Pub. Date: Oct. 7, 2021

(54) ALUMINA SUPPORTED Pt/Ce-Zr MIXED OXIDE CATALYSTS AND METHOD OF MAKING

(71) Applicant: Toyota Motor Engineering & Manufacturing North America, Inc., Plano, TX (US)

(72) Inventors: Krishna Gunugunuri, Canton, MI (US); Charles A. Roberts, Farmington Hills, MI (US); Torin C. Peck, Ann Arbor, MI (US)

(73) Assignee: Toyota Motor Engineering & Manufacturing North America, Inc., Plano, TX (US)

(21) Appl. No.: 16/838,406

(22) Filed: Apr. 2, 2020

(51) Int. Cl. B01J 23/63; B01J 23/00; B01J 6/00; F01N 3/08; B01J 37/03

(52) U.S. Cl. CPC B01J 23/63; B01J 23/002; B01J 21/04; F01N 3/0814; B01J 37/03; B01J 6/001

(57) ABSTRACT

Catalysts for passive NOx absorber to remove NOx from exhaust gas system during engine cold start operation having high storage capacity and ideal desorption properties. The catalysts may include a system having an alumina supported Pt/Ce—Zr mixed oxide catalysts material synthesized by deposition co-precipitation using a precipitation agent selected from the group consisting of ammonium hydroxide (NH₄OH), ammonium carbonate ((NH₄)₂CO₃), sodium hydroxide (NaOH), sodium carbonate (Na₂CO₃).

### TECHNICAL FIELD

The present disclosure generally relates to alumina supported Pt/Ce—Zr mixed oxide catalysts materials for passive NOx storage applications, a method of making the catalyst materials, and a method of using the catalyst materials.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

The control of NOx emissions from lean-burn engines represents an on-going challenge to the automotive industry, particularly at the low exhaust temperatures (e.g., room temperature to about 250° C.) associated with modern, fuel efficient engines. While the factors limiting low temperature NOx control by catalyst-based aftertreatment systems are well recognized, the performance of current catalyst formulations is insufficient at the low exhaust temperatures expected for newer engines currently under development.

### SUMMARY

This section provides a general summary of the disclosure and is not a comprehensive disclosure of its full scope or all of its features.

The present disclosure relates to catalyst for passive NOx absorber to remove NOx from exhaust gas systems during engine cold start operations.

In one aspect, the present disclosure provides a catalyst system for passive NOx adsorption, comprising an alumina supported Pt promoted Ce—Zr mixed oxide catalyst material synthesized by deposition co-precipitation using a precipitation agent selected from the group consisting of ammonium hydroxide (NH₄OH), ammonium carbonate ((NH₄)₂CO₃), sodium hydroxide (NaOH), sodium carbonate (Na₂CO₃). In one or more embodiments, such alumina supported Pt/Ce—Zr mixed oxide catalyst materials exhibit higher NOx storage capacity as compared to: (1) Pt/Ce—Zr mixed oxide catalyst material without alumina, (2) Pt/Ce—Zr mixed oxide catalyst materials synthesized with other precipitating agents, (3) previously used Pt/BaO/Al₂O₃ catalyst material(s), and/or Pt/Ce—Zr mixed oxide catalyst materials made by other methods, such as conventional wetness impregnation.

In another aspect, the present disclosure provides a method for making an alumina supported Pt promoted Ce—Zr mixed oxide catalyst material, comprising deposition co-precipitation using an ammonium carbonate precipitation agent.

In another aspect, the present disclosure provides a method for passive NOx adsorption comprising contacting a lean gas stream with an alumina supported Pt promoted Ce—Zr mixed oxide catalyst material synthesized by deposition co-precipitation using a precipitation agent selected from the group consisting of ammonium hydroxide (NH₄OH), ammonium carbonate ((NH₄)₂CO₃), sodium hydroxide (NaOH), sodium carbonate (Na₂CO₃).

### DRAWINGS

The present disclosure will become more fully understood from the detailed description and the accompanying drawings wherein:

FIG. 1 illustrates NOx storage capacity values of Pt/Ce_{0.5}Zr_{0.5}O₂ and Pt/Ce_{0.5}Zr_{0.5}O₂/Al₂O₃ catalysts.

FIGS. 2(a) and 2(b) illustrate NOx release profiles of the (a) Pt/Ce_{0.5}Zr_{0.5}O₂ and (b) Pt/Ce_{0.5}Zr_{0.5}O₂/Al₂O₃ oxides during temperature programmed desorption.

FIGS. 3(a) to 3(d) illustrate Ce 3d XPS profiles of the Ce_{0.5}Zr_{0.5}O₂ oxides synthesized by the different precipitating agents.

FIGS. 4(a) to 4(d) illustrate Ce 3d XPS profiles of the Ce_{0.5}Zr_{0.5}O₂/Al₂O₃ oxides synthesized by the different precipitating agents.

FIG. 5 illustrates NOx storage capacity values of a Pt/Ce-Zr/Al₂O₃ catalyst synthesized by deposition-coprecipitation compared to a Pt/Ce-Zr/Al₂O₃ prepared by a conventional wetness impregnation method.

FIG. 6 illustrates NOx release profiles of the (a) Pt/Ce_{0.5}Zr_{0.5}O₂/Al₂O₃ catalyst synthesized by deposition-coprecipitation compared to a Pt/Ce-Zr/Al₂O₃ prepared by a conventional wetness impregnation method during temperature programmed desorption.

FIG. 7 illustrates the Ce 3d XPS profile of the Pt/Ce-Zr/Al₂O₃ prepared by a conventional wetness impregnation method.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DESCRIPTION

The use of a passive NOx adsorber (PNA) device during cold start operation is considered for controlling NOx emissions from lean-burn engines at low exhaust temperatures (e.g., room temperature to about 250° C.). In this system, the PNA adsorbs NOx emitted from the engine during cold starts, and then releases the NOx at higher exhaust temperatures. Then the under-floor catalyst is sufficiently active to function efficiently.

The present disclosure relates to the development of an effective catalyst for NOx storage that would eliminate the NOx during engine cold start operation.

Particularly, the present disclosure relates to alumina supported Pt/Ce—Zr mixed oxide catalysts materials for passive NOx storage applications synthesized by a deposition co-precipitation method using a precipitation agent selected from the group consisting of ammonium hydroxide (NH₄OH), ammonium carbonate ((NH₄)₂CO₃), sodium hydroxide (NaOH), sodium carbonate (Na₂CO₃). In an exemplary embodiment, an alumina supported Pt/Ce—Zr mixed oxide catalyst material may comprise Pt/Ce_{0.5}Zr_{0.5}O₂/Al₂O₃, synthesized by a deposition co-precipitation method using a precipitation agent selected from the group consisting of ammonium hydroxide (NH₄OH), ammonium carbonate ((NH₄)₂CO₃), sodium hydroxide (NaOH), sodium carbonate (Na₂CO₃). Such Pt/Ce_{0.5}Zr_{0.5}O₂/Al₂O₃ catalyst materials exhibit higher NOx storage capacity compared to Pt/Ce_{0.5}Zr_{0.5}O₂ without alumina. Additionally, the Pt/Ce_{0.5}Zr_{0.5}O₂/Al₂O₃ catalysts synthesized by deposition co-precipitation using ammonium carbonate as the precipitating agent exhibit two times higher storage capacity compared to previously used Pt/BaO/Al₂O₃. The Pt/Ce_{0.5}Zr_{0.5}O₂/Al₂O₃ catalysts synthesized by coprecipitation using an ammonium carbonate precipitating agent also exhibit an ideal NO thermal desorption range for practical application of a passive NOx adsorber. Remarkably, as compared to a Pt/Ce-Zr/Al₂O₃ prepared by a conventional wetness impregnation method, the Pt/Ce_{0.5}Zr_{0.5}O₂/Al₂O₃ catalysts synthesized by deposition-coprecipitation using ammonium carbonate as the precipitating agent shows higher Ce³⁺ cations and exhibits 1.8 times higher storage capacity and ideal desorption properties.

As used herein, the terms “absorb,” “adsorb,” and any derivatives thereof are used interchangeably, and the specification should be interpreted accordingly.

The present inventors have developed a Pt promoted catalyst for passive NOx adsorption to remove NOx from exhaust gas system during engine cold start operations. The catalyst has a general composition of Pt/Ce_{0.5}Zr_{0.5}O₂/Al₂O₃. In an embodiment, the alumina support may be stabilized with a material such as lanthanum, zirconia, titania, alkaline earth metal oxides such as barium, calcium or strontium or, most usually, rare earth metal oxides, for example, oxides of cerium, lanthanum, neodymium, praseodymium and mixtures of two or more rare earth metal oxides, including the commercially available mixtures of rare earth metal oxides For example, the alumina support may be a lanthanum (La) stabilized Al₂O₃ support containing 2 to 5% lanthanum. The molar ratio of Ce_{0.5}Zr_{0.5}O₂ to La stabilized may be in the range of 1:0.5 to 1:10. In an embodiment, the molar ratio of Ce_{0.5}Zr_{0.5}O₂ to La stabilized Al₂O₃ is 1:1.

The alumina supported Pt promoted Ce_{0.5}Zr_{0.5}O₂ catalyst materials may be synthesized by a deposition co-precipitation method using different precipitating agents. For example, the required amounts of metal nitrate precursors may be dissolved separately in water and the resulting solutions mixed together. The precipitating agent, such as, for example, NH₄OH, NaOH, (NH₄)₂CO₃, and Na₂CO₃, may be separately dissolved in water and the resulting precipitating agent solution added to the metal precursor solution in a dropwise fashion. The reactants may be stirred constantly until a desired pH, such as, for example, a pH of 9-13, and particularly 9-10, is reached. The supernatant liquid may be decanted and filtered to obtain a precipitate. The precipitate may be dried, ground into a fine powder and then calcined.

Suitable metal precursors for cerium may include, but are not limited to, cerium nitrate (Ce(NO)₃), ammonium cerium nitrate ((NH₄)₂Ce(NO₃)₆), cerium chloride (CeCl₃), and cerium sulphate (Ce(SO₄)₂). Suitable metal precursors for zirconium include, but are not limited to, zirconium oxynitrate (ZrO(NO₃)₂), zirconium chloride (ZrCl₄), and zirconium acetate (Zr(CH₃COO)₂). Calcining may be at a predetermined temperature range of from about 500-1000° C. at a predetermined time of about 2 to 50 hrs. at a predetermined ramp rate of about 1 to 20° C./min. In an embodiment, the catalyst is calcined at a predetermined temperature 600° C. for 3 hours at a predetermined ramp rate of about 2° C./min.

To obtain the alumina supported Pt/Ce_{0.5}Zr_{0.5}O₂ catalyst material of the present disclosure, Pt may be deposited on a Ce—Zr/Al₂O₃ support by a wet impregnation method. For example, the Ce—Zr/Al₂O₃ support may be mixed with water to make a support suspension. A platinum nitrate solution may be added to the support suspension and the mixture heated with stirring. The obtained powder may be dried and then calcined at a predetermined temperature, predetermined time, and predetermined ramp rate (such as, for example, those recited herein) to obtain a catalyst having the desired properties. For example, calcining may be at a temperature of from about 400-1000° C. for about 2 to 50 hrs. at a ramp rate of about 1 to 20° C./min.

The alumina supported Pt promoted Ce—Zr mixed oxide catalyst material synthesized by a deposition co-precipitation method using a precipitation agent selected from the group consisting of ammonium hydroxide (NH₄OH), ammonium carbonate ((NH₄)₂CO₃), sodium hydroxide (NaOH), sodium carbonate (Na₂CO₃) of the present disclosure exhibits superior NOx storage capacity compared to Pt promoted Ce—Zr mixed oxide catalyst material without alumina. Also, the alumina supported Pt/Ce_{0.5}Zr_{0.5}O₂ catalyst synthesized using a deposition co-precipitation method using ammonium carbonate as the precipitating agent exhibit two times higher storage capacity compared to a previously used Pt/BaO/Al₂O₃ catalyst material. As a result of changing the precipitating agent to control the NOx desorption properties of the catalyst, the alumina supported Ce—Zr mixed oxide catalyst material of the present disclosure also exhibits an ideal NO thermal desorption range for practical application of a passive NOx adsorber. Remarkably, as compared to a Pt/Ce—Zr/Al₂O₃ prepared by a conventional wetness impregnation method, the Pt/Ce_{0.5}Zr_{0.5}O₂/Al₂O₃ catalyst synthesized by deposition-coprecipitation using ammonium carbonate as the precipitating agent exhibits 1.8 times higher storage capacity and ideal desorption properties.

### Examples

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Synthesis and Material Characterization

Ce_{0.5}Zr_{0.5}O₂/Al₂O₃ catalysts were synthesized by using a deposition co-precipitation method using four different precipitating agents namely NH₄OH, NaOH, (NH₄)₂CO₃, and Na₂CO₃. In a typical synthesis procedure, the required amounts of Ce(NO₃)₃ and ZrO(NO₃)₂ were dissolved separately in deionized water and mixed together. On the other hand, the required amount of La stabilized Al₂O₃ (containing 2 to 5% lanthanum) was dispersed in 200 ml of water and mixed with Ce, Zr nitrate solutions (molar ratio of Ce_{0.5}Zr_{0.5}O₂ to La stabilized Al₂O₃ is 1:1). The precipitating agents were also dissolved in water to form a precipitating agent solution. The precipitating agent solution was slowly added to the metal nitrate solution in a dropwise manner. The pH of the solution was constantly monitored as the precipitating agent solution was added. The reactants were constantly stirred using a magnetic stirrer until a pH level of 9-10 was reached. The supernatant liquid was then decanted and filtered to obtain the precipitate. The precipitate was then dried overnight at 120° C. The acquired substance was then ground into a fine powder. Finally, the catalysts were calcined at 600° C. (2° C./min ramp rate) for 3 hours.

Pure Ce_{0.5}Zr_{0.5}O₂ catalysts were also synthesized without alumina by using the same method for reference.

In an example, 1 wt % Pt was deposited on Ce_{0.5}Zr_{0.5}O₂ and Ce_{0.5}Zr_{0.5}O_{2/}Al₂O₃ using a wet impregnation method. 1 gm of the support was mixed with 50 mL of water. Then the required quantity of platinum nitrate solution was added to the support suspension. The mixture was heated to 80° C. with continuous stirring. The powder obtained was then dried in an oven at 120° C. for 12 hours under air. Finally, the catalyst was calcined at 450° C. for 3 hours with a 1° C. min⁻¹ ramp.

The specific surface area of the materials Pt/Ce_{0.5}Zr_{0.5}O₂ and Pt/Ce_{0.5}Zr_{0.5}O_{2/}Al₂O₃ were measured using a Micromeritics 3Flex surface characterization instrument. N₂ physisorption isotherms were collected at −196° C., and the surface area was measured by the 11-point BET method. Before the analyses, the samples were outgassed at 300° C. under vacuum (5×10⁻³ Torr) for three hours.

XPS measurements were performed using PHI 5000 Versa Probe II X-ray photoelectron spectrometer using an Al Kα source. Survey scans (with 187.85 eV pass energy at a scan step of 0.8 eV) and high resolution (O 1s), (Pd 3d) and (C 1s) scans (with 23.5 eV pass energy at a scan step of 0.1 eV) were performed. Charging of the catalyst samples was corrected by setting the binding energy of the adventitious carbon (C 1s) to 284.6 eV. The XPS analysis was performed at ambient temperature and at pressures typically on the order of 10⁻⁷ Torr. Prior to the analysis, the samples were outgassed under vacuum for 30 mins.

NOx storage experiments were performed in Netzsch thermogravimetric analyzer coupled with mass spectroscopy. Prior to storage, the material was pretreated to 600° C. in the presence of CO₂ and O₂ (9% CO₂, 9% O₂ balance Ar) to remove the adsorbed impurities. After the pretreatment, the temperature is decreased to 100° C. in the presence of CO₂ and O₂, and the NOx storage was performed at 100° C. for 30 min using NO+CO₂+O₂ mixture (1500 ppm NO+9% CO₂+9% O₂ balance Ar). After NOx storage, the temperature was ramped from 100-600° C. in the presence of CO₂ and O₂ to desorb the NO.

### Performance Evaluation

The alumina supported Pt promoted Ce_{0.5}Zr_{0.5}O₂ catalysts were developed for passive NOx adsorption applications.

Based on performance testing discussed herein, the Pt/Ce_{0.5}Zr_{0.5}O₂/Al₂O₃ catalyst materials synthesized by a deposition co-precipitation method using a precipitation agent selected from the group consisting of ammonium hydroxide (NH₄OH), ammonium carbonate ((NH₄)₂CO₃), sodium hydroxide (NaOH), sodium carbonate (Na₂CO₃) exhibit higher surface area as compared to Pt/Ce_{0.5}Zr_{0.5}O₂ (i.e., without an alumina support). The specific surface areas of the samples are provided in Table 1 below. These measurements show that depositing Ce—Zr on alumina increases the surface area.

TABLE 1
BET surface are values of Pt/Ce-Zr and Pt/Ce-Zr/Al catalysts.

| Precipitating agent | Pt/Ce-Zr | Pt/Ce-Zr/al |
|---|---|---|
| NH₄OH | 78 | 95 |
| (NH₄)₂CO₃ | 62 | 70 |
| NaOH | 78 | 105 |
| Na₂CO₃ | 21 | 61 |

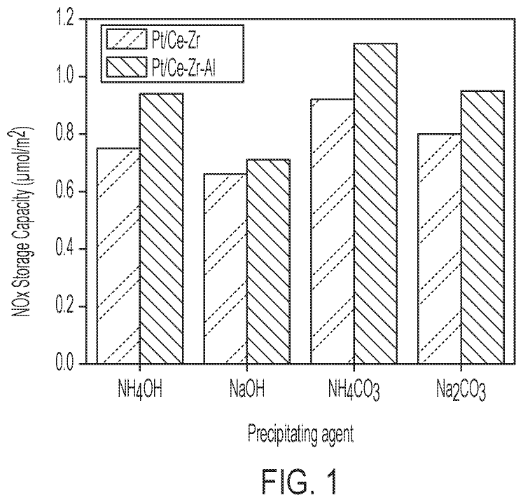

Passive NOx adsorption experiments were performed at 100° C. over Pt promoted Ce_{0.5}Zr_{0.5}O₂/Al₂O₃ and Ce_{0.5}Zr_{0.5}O₂ catalysts synthesized by different precipitating agents. The NOx storage capacity values of Pt promoted catalysts are presented in FIG. 1. Since there is a difference in the surface area of the catalysts as shown in Table 1 above, the NOx storage capacity values are presented as storage capacity per m² surface area. Surprisingly, all of the Pt/Ce_{0.5}Zr_{0.5}O₂/Al₂O₃ catalysts exhibit better storage capacity compared to the Pt/Ce_{0.5}Zr_{0.5}O₂ catalysts even after normalizing per surface area. Thus, based on the measurements, it can be determined that alumina not only improves the surface area, but also modifies the structure of the catalysts to improve the storage properties of the catalysts.

It was also surprisingly found that the precipitating agent has a significant influence on the NOx storage properties of the Pt/Ce_{0.5}Zr_{0.5}O₂/Al₂O₃ catalysts. Each of the four catalysts obtained from the four different precipitating agents exhibits different NOx storage capacity values. Among the various catalysts, Pt/Ce_{0.5}Zr_{0.5}O₂/Al₂O₃ catalyst synthesized with ammonium carbonate as the precipitating agent exhibits the highest NOx storage capacity. Remarkably, the Pt/Ce_{0.5}Zr_{0.5}O₂/Al₂O₃ catalyst synthesized using ammonium carbonate as the precipitating agent (1.1 μmol/m²) also exhibits more than 2 times higher NOx storage capacity compared to the previously used Pt/BaO/Al₂O₃ (0.4 μmol/m²).

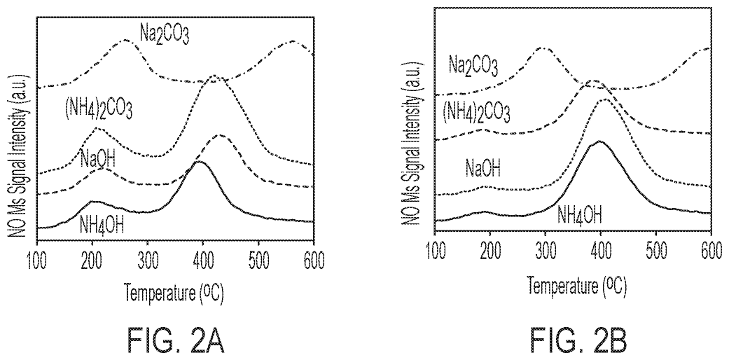

After NOx storage, the temperature was ramped from 100 to 600° C. in the presence of CO₂ and O₂ to release the stored NO. The NOx release profiles of the Pt/Ce_{0.5}Zr_{0.5}O₂ and Pt/Ce_{0.5}Zr_{0.5}O₂/Al₂O₃ oxides during temperature programmed desorption are presented in FIGS. 2(a) and 2(b). For practical applications NOx should be released between 200-500° C. (typical exhaust temperature for diesel and gasoline underfloor catalysts). All the Pt/Ce_{0.5}Zr_{0.5}O₂ catalysts release more than 95% of NO at temperatures exceeding 200° C. These measurements show that Al₂O₃ supported catalysts exhibit improved desorption properties compared to catalysts without alumina. Also, the precipitating agent has an influence on the NOx desorption properties of the Pt/Ce_{0.5}Zr_{0.5}O₂/Al₂O₃ catalysts. These measurements show that the NOx desorption properties can be controlled by just changing the precipitating agent during synthesis. Remarkably, Pt/Ce_{0.5}Zr_{0.5}O₂/Al₂O₃ catalyst synthesized using ammonium carbonate as the precipitating agent desorbs more than 99% of NO after 200° C. compared to the other precipitating agents. On the whole, the NOx storage measurements show that alumina supported Pt/Ce_{0.5}Zr_{0.5}O₂ catalysts exhibit higher storage capacity and improved desorption properties compared to the Pt/Ce_{0.5}Zr_{0.5}O₂ catalysts without alumina.

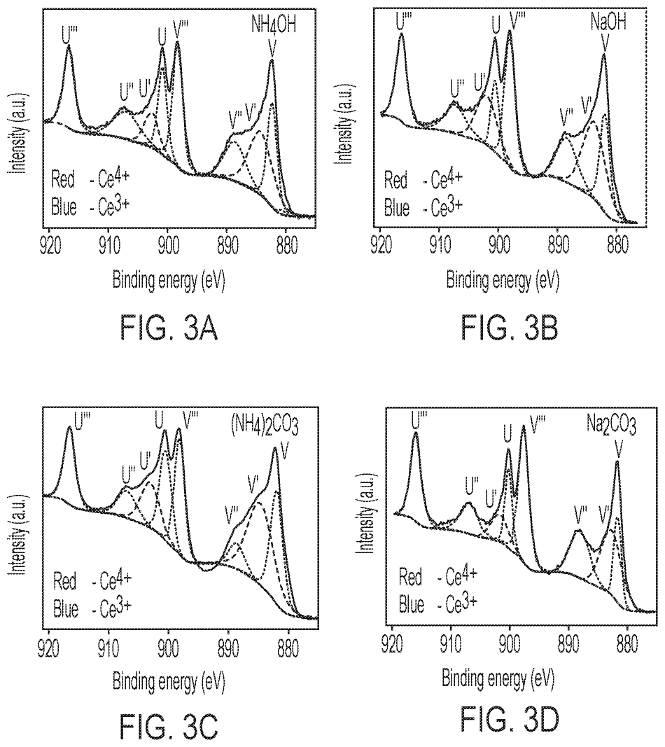

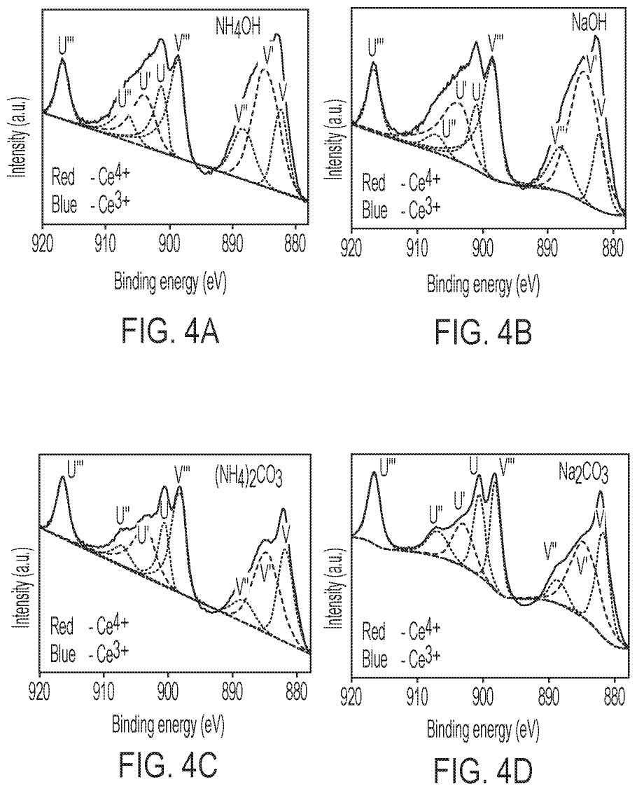

Ce 3d XPS profiles of the Ce_{0.5}Zr_{0.5}O₂ and Ce_{0.5}Zr_{0.5}O₂/Al₂O₃ mixed oxides synthesized by the different precipitating agents are presented in FIGS. 3(a) to 3(d) and FIGS. 4(a) to 4(d), respectively. The XPS profiles show peaks labelled μ which are due to Ce3d_{3/2} spin orbit state and peaks labelled ν which are due to Ce3d_{5/2} spin orbit state. The peaks labeled μ″′, μ″, μ and ν″′, ν″, and ν all are due to Ce⁴⁺ oxidation state only. In addition to the peaks due to the Ce⁴⁺ oxidation state, all the catalysts also exhibit two additional peaks at 902.6 (μ′) and 884.8 eV (ν′). These peaks arise from 5/2 and 3/2 spin orbit states of Ce³⁺ oxidation state. These measurements show that incorporation of zirconium into the ceria lattice leads to cerium 4+ and 3+ oxidation states. Interestingly, all the Ce—Zr catalysts exhibit peaks due to both 4+ and 3+ oxidation states. It is difficult to calculate the amount of Ce³⁺ in the Ce—Zr catalysts since μ′ and ν′ peaks are surrounded by 4+ oxidation state peaks. However, the μ″′ peak is not surrounded by any other peaks and the μ″′ peak belongs to 4+ oxidation state. Hence, the area under the μ″′ peak is used to calculate the amount of 3+ oxidation state in the Ce—Zr catalysts. In this regard, the lesser the area of the μ″′ peak, the higher the Ce³⁺ amount is in the catalyst.

The percent (%) of the μ″′ peak area to the total area of Ce—Zr catalysts are presented in Table 2. As shown in Table 2, all the Ce—Zr/Al materials contain more Ce³⁺ ions (lesser μ″′ peak area) compared to the Ce—Zr materials without alumina. It is well known that Ce⁴⁺/Ce³⁺ redox couple plays a major role during NOx storage in the passive NOx adsorption application. These measurements show that supporting Ce—Zr on alumina increases the Ce³⁺ amount and improves the NOx storage properties.

TABLE 2
% of μ′′′ peak area to the total area of Ce-Zr and Ce-Zr/Al
catalysts synthesized by the different precipitating agents.

| | % of μ′′′ peak area to the total area | |
|---|---|---|
| Precipitating agent | Ce_{0.5}Zr_{0.5}O₂ | Ce_{0.5}Zr_{0.5}O₂/Al₂O₃ |
| NH₄OH | 12.3 | 6.96 |
| (NH₄)₂CO₃ | 10.8 | 8.69 |
| NaOH | 12.4 | 7.33 |
| Na₂CO₃ | 14.2 | 11.15 |

### Comparative Example

The Pt/Ce_{0.5}Zr_{0.5}O₂/Al₂O₃ catalyst synthesized by the present deposition-coprecipitation method using ammonium carbonate as a precipitating agent was further compared to a comparative Pt/CeO₂-ZrO₂/Al₂O₃ catalyst prepared by conventional incipient wetness impregnation.

The comparative Pt/Ce—Zr/Al₂O₃ catalyst was prepared by the wet impregnation method reported by Andonova et al, “Pt/CeOx/ZrOx/γ-Al₂O₃ Ternary Mixed Oxide DeNOx Catalyst: Surface Chemistry and NOx Interactions. J. Phys. Chem. C. 122 (2018) 12850-12863. For this purpose, appropriate amounts of aqueous solutions of Ce—(NO₃)₃.6H₂O (Sigma-Aldrich, 99.99%) and/or ZrO(NO₃)₂.xH₂O (Sigma-Aldrich 99.99%) were used to achieve 20 wt % total metal oxide (10 wt % of CeO₂+10 wt % of ZrO₂) in the final product. The precursor solutions were mixed with La stabilized γ-Al₂O₃ and the slurry was continuously stirred followed by evaporation at 350 K until the water from the suspension was completely removed. The resulting solids were then dried and calcined at 600° C. for 3 hours. These mixed oxide support materials were further functionalized with the addition of platinum. For this purpose, a Pt nitrate precursor solution, dilute ammonium hydroxide, Sigma-Aldrich) was prepared, and then, the support material was slowly added to the solution under constant stirring at room temperature (RT). Next, the slurry was continuously stirred, and the solvent was evaporated at 80° C. Finally, the products were ground into a fine powder form and calcined at 450° C. for 3 hours. The nominal noble metal loading (1 wt % Pt) was kept constant similar to our Pt/Ce—Zr/Al₂O₃ samples synthesized by deposition-coprecipitation method followed by the impregnation.

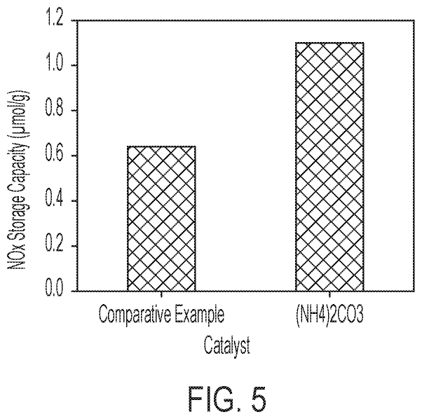

A passive NOx adsorption experiment was performed at 100° over the Pt/Ce-Zr/Al₂O₃ catalyst prepared by conventional wetness impregnation. The NOx storage capacity values of the Pt/Ce_{0.5}Zr_{0.5}O₂/Al₂O₃ catalyst synthesized by the present deposition co-precipitation method and the comparative Pt/Ce—Zr/Al₂O₃ catalyst prepared by conventional wetness impregnation are provided in FIG. 5. Referring to FIG. 5, the Pt/Ce_{0.5}Zr_{0.5}O₂/Al₂O₃ catalyst synthesized by the present deposition co-precipitation method using ammonium carbonate as a precipitating agent exhibits 1.8 times better NOx storage capacity compared to the comparative Pt/Ce—Zr/Al₂O₃ catalyst prepared by conventional wetness impregnation.

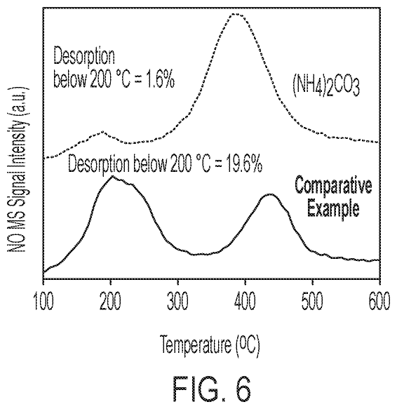

The NOx release profiles of the Pt/Ce_{0.5}Zr_{0.5}O₂/Al₂O₃ catalyst synthesized by the present deposition co-precipitation method and the comparative Pt/Ce—Zr/Al₂O₃ catalyst prepared by conventional wetness impregnation are provided in FIG. 6. Referring to FIG. 6, NOx desorption measurements show the Pt/Ce_{0.5}Zr_{0.5}O₂/Al₂O₃ catalyst synthesized by the present deposition co-precipitation method using ammonium carbonate as a precipitating agent exhibits ideal desorption properties for practical applications. On the other hand, the comparative Pt/Ce-Zr/Al₂O₃ catalyst synthesized by a conventional wetness impregnation method desorbs 20% of NO below 200° C., which is not suitable for the practical applications.

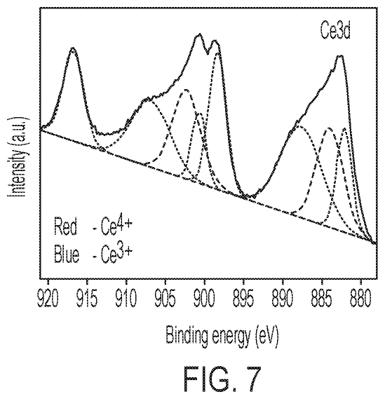

The Ce 3d XPS profile of the comparative Pt/Ce—Zr/Al₂O₃ catalyst synthesized by a conventional wetness impregnation method. Referring to FIG. 7, the Pt/Ce—Zr/Al₂O₃ material synthesized by a conventional wetness impregnation method also exhibits peaks due to Ce⁴⁺ and Ce³⁺ oxidation states. However, as shown in Table 3, the Pt/Ce—Zr/Al₂O₃ materials synthesized by a conventional wetness impregnation method exhibit a much higher % of μ″′ peak area compared to the Pt/Ce_{0.5}Zr_{0.5}O₂/Al₂O₃ catalyst synthesized by the present deposition co-precipitation method using ammonium carbonate. This shows that the Pt/Ce_{0.5}Zr_{0.5}O₂/Al₂O₃ catalysts synthesized by the present deposition co-precipitation method using ammonium carbonate contain much higher Ce³⁺ cations compared to the Pt/Ce—Zr/Al₂O₃ materials synthesized by a conventional wetness impregnation method, and therefore are structurally different. The higher amount of Ce³⁺ cations of the Pt/Ce_{0.5}Zr_{0.5}O₂/Al₂O₃ catalysts synthesized by the present deposition co-precipitation method using ammonium carbonate contributes to the higher storage capacity and improved desorption properties compared to the Pt/Ce—Zr/Al₂O₃ materials synthesized by a conventional wetness impregnation method.

TABLE 3
% of μ′′′ peak area to the total area of a Ce_{0.5}Zr_{0.5}O₂/Al₂O₃
catalyst synthesized by deposition co-precipitation using
ammonium carbonate and the comparative Ce_{0.5}Zr_{0.5}O₂/Al₂O₃
catalyst prepared by conventional wetness impregnation.

| | % of μ′′′ peak area to the total area |
|---|---|
| Precipitating agent | Ce_{0.5}Zr_{0.5}O₂/Al₂O₃ |
| Comparative Example | 10.2 |
| (NH₄)₂CO₃ | 8.69 |

Overall the NOx comparative data show that the Pt/Ce_{0.5}Zr_{0.5}O₂/Al₂O₃ catalyst synthesized by the present deposition co-precipitation method using ammonium carbonate of the present disclosure are structurally different and exhibit superior NOx storage capacity, and NOx desorption properties as compared to Pt/Ce—Zr/Al₂O₃ materials synthesized by a conventional wetness impregnation method.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A catalyst for passive NOx adsorption comprising an alumina supported Pt promoted Ce—Zr mixed oxide catalyst material synthesized by deposition co-precipitation using a precipitation agent selected from the group consisting of ammonium hydroxide (NH₄OH), ammonium carbonate ((NH₄)₂CO₃), sodium hydroxide (NaOH), sodium carbonate (Na₂CO₃).

2. The catalyst according to claim 1, wherein the precipitation agent comprises ammonium carbonate ((NH₄)₂CO₃).

3. The catalyst according to claim 1, wherein the alumina supported Pt promoted Ce—Zr mixed oxide comprises Pt/Ce_{0.5}Zr_{0.5}O₂/Al₂O₃.

4. The catalyst according to claim 1, wherein the alumina is stabilized with a material selected from the group consisting of lanthanum, zirconia, titania, alkaline earth metal oxides, rare earth metal oxides and mixtures of two or more rare earth metal oxides.

5. The catalyst according to claim 4, wherein the alumina is stabilized with lanthanum.

6. The catalyst according to claim 1, wherein said alumina supported Pt promoted Ce—Zr mixed oxide catalyst material has an enhanced NOx storage capacity at a temperature in the range of from room temperature to about 250° C.

7. The catalyst according to claim 1, wherein said alumina supported Pt promoted Ce—Zr mixed oxide catalyst material has an enhanced NOx storage capacity at a temperature of about 100° C.

8. A method for making an alumina supported Pt promoted Ce—Zr catalyst material by a deposition co-precipitation method, said method comprising:
mixing a cerium precursor aqueous solution with a zirconium precursor aqueous solution;
adding ammonium carbonate ((NH₄)₂CO₃) as a precipitation agent to obtain a precipitate;
drying the obtained precipitate; and
calcining the dried precipitate.

9. The method according to claim 8, wherein the alumina supported Pt promoted Ce—Zr mixed oxide catalyst material comprises Pt/Ce_{0.5}Zr_{0.5}O₂/Al₂O₃.

10. The method according to claim 8, wherein the cerium precursor is selected from the group consisting of cerium nitrate (Ce(No₃)₃), ammonium cerium nitrate ((NH₄)₂Ce(NO₃)₆), cerium chloride (CeCl₃), and cerium sulphate (Ce(SO₄)₂).

11. The method according to claim 10, wherein the cerium precursor is cerium nitrate (Ce(NO₃)₃.

12. The method according to claim 8, wherein the zirconium precursor is selected from the group consisting of zirconium oxynitrate (ZrO(NO₃)₂), zirconium chloride (ZrCl₄), and zirconium acetate (ZrAc).

13. The method according to claim 12, wherein the zirconium precursor comprises zirconium oxynitrate (ZrO(NO₃)₂).

14. The method according to claim 8, wherein the calcining is conducted at a temperature of from about 500-1000° C.

15. The method according to claim 14, wherein the calcining is conducted for a time of about 2 to 50 hrs.

16. The method according to claim 15, wherein the calcining is conducted at a ramp rate of about 1 to 20° C./min.

17. The method according to claim 8, wherein the calcining is conducted at a temperature of about 600° C.

18. The method according to claim 17, wherein the calcining is conducted for a time of about 3 hours.

19. The method according to claim 18, wherein the calcining is conducted at a ramp rate of about 2° C./min.

20. A method for passive NOx adsorption, the method comprising contacting a lean gas stream with an alumina supported Pt promoted Ce—Zr mixed oxide catalyst material synthesized by deposition co-precipitation using a precipitation agent selected from the group consisting of ammonium hydroxide (NH₄OH), ammonium carbonate ((NH₄)₂CO₃), sodium hydroxide (NaOH), sodium carbonate (Na₂CO₃).

21. The method according to claim 20, wherein the precipitation agent comprises ammonium carbonate ((NH₄)₂CO₃).
